(19) United States
(12) Patent Application Publication
(10) Pub. No.: US 2003/0224336 A1
(43) Pub. Date: Dec. 4, 2003

(54) Home activity calendar (responsible football league)

(76) Inventor: Keith Scott Jackson, Roswell, GA (US)

Correspondence Address: KEITH S. JACKSON, 637 Old Ivy Chase, Riverdale, GA, 30274, US

(21) Appl. No.: 10/158,446

(22) Filed: May 31, 2002

(51) Int. Cl. G09B 19/00

(52) U.S. Cl. 434/238

(57) ABSTRACT

An entertaining and educational sports calendar that would encourage good behavior in children. The appealing features of the calendar would be its ability to be used to encourage proper behavior in children. The versatile calendar could also provide positive reinforcement and structure for the family. The calendar is intended to facilitate communications between parents and children regarding facts and attitudes in the area of children's responsibility. The calendar will provide learning experiences, which will lead to improved communication between parents and children. The calendar will feature colorful graphics and would be easy to hang in any prominent location. The calendar is 0.30×0.24 made on poster paper. It is a wall calendar with all twelve months showing. There is a section where daily chores and responsibilities would be listed. When a chore is completed yardage is gained. There is an area to place chores that are not done. Behaving correctly and receiving yardage and touchdowns could give the child a since of accomplishment. It would also tech the child about responsibility for actions or inaction and could serve to build character.

A board game wherein each player represents the owner of a sports team and the object of the game is to build a profitable and winning team. Each user advances a playing piece along an endless path of continuous spaces and is free to engage in deal making involving trades and sales with the other owners. This may be directed toward any suitable team sport since it is more closely related to the business aspects of sports and requires only minimal knowledge of the rules of the sport itself.

### STATEMENT REGARDING FEDERALLY SPONSORED RESEARCH OR DEVELOPMENT

“Not Applicable”

### REFERENCE TO SEQUENCE LISITING, A TABLE, OR COMPUTER PROGRAM LISTING COMPACT DISC APPENDIX

“Not Applicable”

### BACKGROUND OF THE INVENTION

It will always be the children who are responsible for the world to keep functioning. The more responsible children become today, the more responsible adults we will have in the future. It is difficult to teach children how to become responsible, and explain the importance of being responsible. Children give excuses when they do something wrong or forget to do something. Children love to win and hate to lose. The Home Activity Calendar will help parents keep track of how responsible their children are and let children show how responsible they can be. Prior art is a listing of things to do on a piece of paper with out sports being associated. Also calendars do not relate to sports and being responsible.

### BRIEF SUMMY OF THE INVENTION

The object of the invention is entertaining, educational and would encourage good behavior in children. There are two graphic pictures of football being played. One picture of running the football to represent when they are responsible. And one picture of getting tackled to represent when they are not responsible. Children do not like to be tackled. Getting tackled will stop excuses. An excuse will not stop children from being tacked and losing yardage. As a result children are more excited to accomplish their chores and try to score a responsible Touch Down each month.

### BRIEF DESCRIPTION OF THE SEVERAL VIEWS OF THE DRAWING

Drawing 1. HOME ACTIVITY CALENDAR, which features a yearly wall calendar with twelve months, proper days and dates. Important dates of the year. Two colorful pictures of football being played against the irresponsible team (x-Team).

FIG. 1A. Graphics representing when responsible plays are being ran and yardage is gained against the irresponsible team x-team.

FIG. 2A. Check plus=Lost Yards Gained Back

FIG. 3A. Check=Yards Gained. When Responsible Plays (chores) are ran a check is written on the calendar for that day and yardage is gained.

FIG. 4A. Name of the calendar. HAC, HOME ACTIVITY CALENDAR

FIG. 5A. The name of the sport on the calendar. RFL 2002, RESPONSIBLE FOOTBALL LEAGUE.

FIG. 6A. The place where chores that need to be done are listed. Daily Responsible Plays. EXAMPLE: Make Bed Every Day, take out the trash, etc.

FIG. 7A. X=Yards Lost. When Daily Responsible Plays are missed an X is written on the calendar for that day.

FIG. 8A. T=Time Out responsible plays do not have to be ran.

FIG. 9A. Graphic representing when responsible plays are not being ran and yards are lost. Being tackled by the x-team and losing yardage.

FIG. 10A. Loss Of Yards. All Responsible Plays that are not run are listed under loss of yards. Example: Bed not made.

FIG. 11A. A diagram of a green football field, numbered white yard lines, end zone with goal post. The yes box is checked when a TOUCHDOWN is made. The no box is checked when a TOUCHDOWN is not made.

FIG. 12A. New Responsible Plays. Any new chore that is not on the daily responsible list that needs to be done. Example: Help your grandmother January 12 at 7:00 p.m.

FIG. 13A. Important dates for the year are listed.

FIG. 14A. KJ MARKETING CONCEPTS INC., Trademark.

FIG. 15A. Children can receive a reward for being responsible all year. The reward will be referred to as a trophy. Example: New computer system.

Drawing 2. Example of HOME ACTIVITY CALENDAR in use.

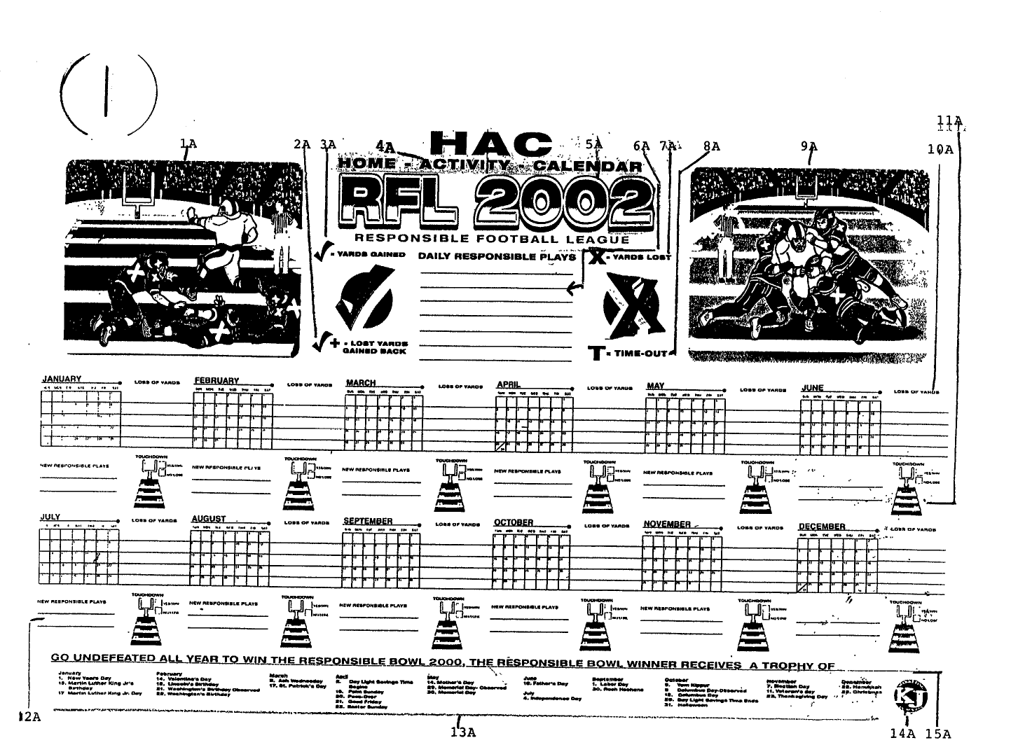

FIG. 1B. The user placing their name on the calendar. The users name is placed on the runner-gaining yardage. Seeing themselves run past the x-team identifies they have been responsible.

FIG. 2B. A list of Daily Responsible Plays is written on the calendar.

FIG. 3B. The user placing their name on the calendar. The users name is placed on the runner being tackled. Seeing themselves being tackled identifies they have not been responsible.

FIG. 4B. Loss of yards, bed not made, is written on the calendar to represent an x that has been placed on the calendar.

FIG. 5B. X is placed on the calendar when responsible plays are not performed.

FIG. 6B. Check is placed on the calendar when responsible plays are performed.

FIG. 7B. A new responsible play is written on the calendar to represent a new play that is not on the daily plays lists.

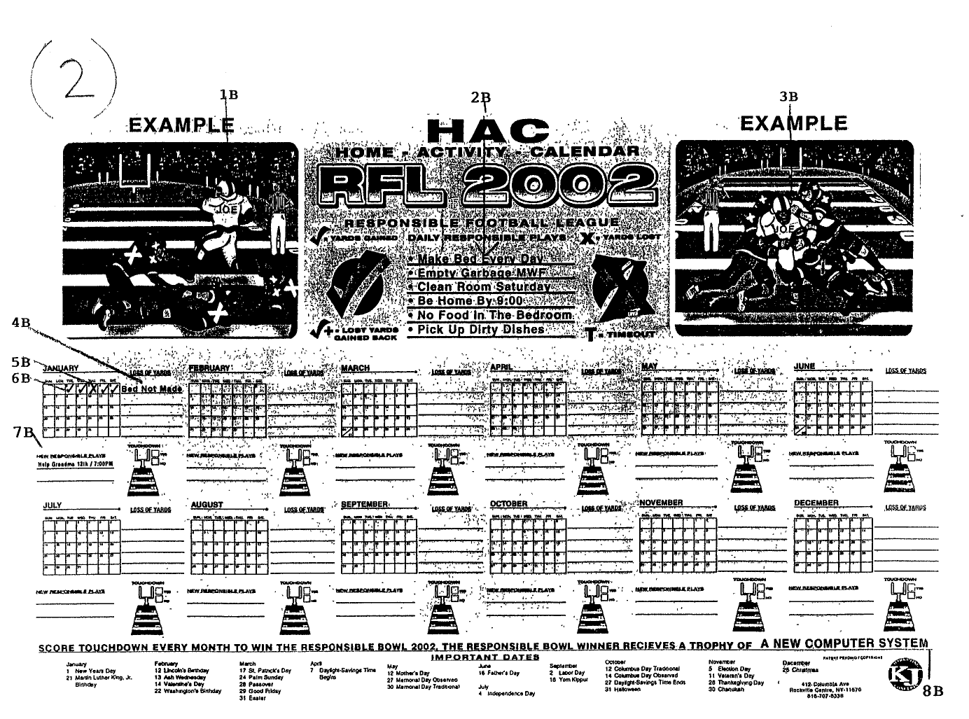

FIG. 8B. A reward for being responsible is written on the calendar.

### DETAILED DESCRIPTION OF THE INVENTION

01. Although the calendar described herein is in the preferred embodiment of football, it should become readily apparent upon reading this detailed description that the calendar is equally well suited for application to numerous other sports. Such sports envisioned by the inventor include, Football, Basketball, Baseball, Car Racing, Jump Rope, Gymnastics and virtually any other sport. The sport to which the calendar may relate, shows an irresponsible team trying to stop the user from being responsible. The appealing features of the Home Activity Calendar would be its ability to encourage proper behavior in children. The versatile calendar set could also provide positive reinforcement and structure for the family. Behaving correctly and receiving yardage for touchdowns could give a child a since of accomplishment. It would also teach the child about responsibility for actions or inaction and could serve to build character. The calendar would feature colorful graphics and would be easy to hang in any prominent location.

02. Referring to Drawing 1, the calendar of the present invention is a wall calendar that shows all twelve months, graphics of football players, 1A, 9A, important dates 13A, the parents (or authority of) would explain various expected chores and behaviors to the child and list them on Daily Responsible Plays area 6A. Each day the child would have to complete these plays as well as any new plays in order to be given credit for yardage. Plays could include doing dishes, taking out the rash, be home by 9:00 PM, etc. Each day if all the responsible plays are completed, the child would receive a check and yardage toward a touchdown. If the plays were not completed, the child would receive an X and lose yardage 7A. This yardage can be made up if the child performs extra responsible plays according to the judgment of the parent or authority (check plus) 2A. The object would be to score a touchdown each month in order to be responsible, defeat the irresponsible team and be responsible.

03. Referring to Drawing 2, An example of the present invention in use. The name of the user can be written on the football player as the user runs responsible plays, runs past the X-team and gains yardage 1B. A list of daily responsible is written on the calendar 2B. The user sees themselves being tackled by the X-team for not running responsible plays 3B. The loss of yardage is written on the calendar when responsible plays are not ran 4B. An X is placed on the calendar on the day a responsible play is missed 5B. A check is placed on the calendar on the days responsible plays are ran 6B. A yearly reward is listed on the calendar 7B.

04. A variety of different studies have proved that the way a child is brought up actually shapes the way the brain grows—and how intelligent the child will be. Genetics plays a role in a child's growth, of coarse. But the ability that parents have to influence that growth is a little short of awesome. Proper stimulation, meaning a rich and diverse environment, will make the child's brain grow denser, thought processes become quicker, and perception keener. Some studies have shown that not only do stimulated children develop more brain synapses, but ignored children actually have less brain mass, and their brains grow less during the first few formative years. Thus, the more exciting and stimulating a child has, the better they will perform, as they grow older. Unlike most responsible tools that narrowly focus on right or wrong, yes no answers, good learning tools go broader and encourage problem solving, provide hands on interaction and challenge a child's imagination. The Home Activity Calendar provides hands on interaction.

What I claim as my invention is:

1. A colorful yearly sports calendar wherein each user represent a football player running responsible plays comprising.
a. A yearly wall calendar showing all twelve months;
b. A list of important dates of the year;
c. A colorful graphic picture of the user running responsible plays, running past the irresponsible team and gaining yardage;
d. A colorful graphic picture of the user not running responsible plays, getting tackled and losing yardage;
e. A calendar using the name Home Activity Calendar;
f. The RFL Responsible Football League, Responsible sport of the calendar.

2. A method of using calendar of claim 1:
a. A check is yards gained and is placed on the calendar when responsible plays (chores) have been completed. Every check puts the user closer to the goal line;
b. A check plus is lost yards gained back, when chores that have been missed are completed;
c. A list of daily Responsible Plays, (chores) are listed;
d. An X is yards lost when chores and responsibilities are not performed. X's move the user away from the goal line;
e. A T=time out, responsible plays (chores) do not have to be performed;
f. A new responsible plays list. Responsibilities not listed on the daily responsible list;
g. A list of important dates during the year;
h. A reward for being responsible;
i. A calendar that will keep children motivated to be responsible.

3. The calendar of claim 1:
a. A way to keep track of a child's responsibilities for the year;
b. The parents, each week and each month can check statistics to see how responsible their children are;
c. A method of playing football on a calendar based on responsibility;
d. A excuse will not stop a loss of yardage.
